(19) United States
(12) Patent Application Publication
(10) Pub. No.: US 2016/0003386 A1
(43) Pub. Date: Jan. 7, 2016

(54) Rotatable Joint

(71) Applicant: MANULI RUBBER INDUSTRIES S.P.A., Milano (IT)

(72) Inventor: Luca Bechis, Milano (IT)

(21) Appl. No.: 14/768,936

(22) PCT Filed: Feb. 22, 2013
(86) PCT No.: PCT/IB2013/051451

§ 371 Date: Aug. 19, 2015

(51) Int. Cl. F16L 27/08; F16L 21/05; F16L 17/02

(52) U.S. Cl. CPC F16L 27/0816; F16L 17/02; F16L 21/05

(57) ABSTRACT

A rotatable joint for flexible pipes is disclosed including two bodies that are rotatable in relation to one another, wherein the pressurised fluid inside the joint generates an axial thrust that would tend to press the two bodies against one another and is balanced by an axial thrust that is almost equal and opposite generated hydraulically by a counterpressure chamber included between the two bodies and between two annular washers arranged between the two bodies and having diameters that are different from one another.

### BACKGROUND OF THE INVENTION

The invention relates to a rotatable joint, in particular for hydraulic connections in hydraulic applications.

Specifically but not exclusively, the invention can be used for connecting a high pressure flexible pipe to an external hydraulic system.

The prior art comprises flexible pipes used for connecting parts of hydraulic plants that have relative movements. These relative movements can cause flexible pipes to become twisted. Rotatable joints are known that enable all or part of this twisting to be absorbed, increasing the useful life of the pipes.

A rotatable joint of known type essentially consists of two elements that are free to rotation with respect to one another. Owing to the pressurised fluid inside the joint, the two elements are pressed against one another by an axial force of significant entity, that could generate great friction resistance if the two elements were directly in contact. For this reason, in the known rotatable joints, rolling elements (for example one or more crowns of balls or rollers) are interposed axially between the two elements, the rolling elements reducing the friction resistance and enabling relative rotation by transforming the sliding friction into rolling friction.

The presence of rolling elements nevertheless reduces the contact surfaces and generates great local stress in the parts of the joint in contact with the rolling elements. The surfaces in contact with the rolling elements, although they are hardened by thermic treatment, are nevertheless subject to more rapid wear, the greater the internal pressure and the rotation angle. The friction resistance also generates an increase in the temperature in the joint that can lead to the collapse of the sealing elements of the joint.

### SUMMARY OF THE INVENTION

One object of the invention is to improve rotatable joints of known type.

One advantage is to provide a rotatable joint that is able to overcome one or more of the limits and drawbacks of the prior art disclosed above.

One advantage is to provide a hydraulic joint in which an internal body and an external body are freely rotatable in relation to one another and in which it is possible to substantially cancel (apart from the tolerances of the dimensions of the cylindrical surfaces of the bodies in contact with the sealing arrangement) the result of the axial thrusts exerted by the pressurised fluid on the internal body.

One advantage is to devise a rotatable joint in which the wear of the relatively rotating parts is relatively reduced.

One advantage is to reduce the temperature increase due to friction resistance, with a consequent increase in the working life of the joint.

One advantage is to devise a rotatable joint to connect a fluid conveying element (for example a flexible pipe) with an external hydraulic system (for example a high pressure pump), in which the transmission of the vibrations is reduced (in particular in an axial direction) through the joint, in particular the vibrations coming from the external hydraulic system.

One advantage is to make a hydraulic joint available in which an internal body and an external body are freely rotatable in relation to one another and in which it is possible to avoid the use of a revolving elements supporting rotation interposed between the external body and the internal body.

One advantage is the significant increase in the working life of the sealing elements of the joint and/or of the fluid conveying element (for example the flexible pipe) connected to the rotatable joint.

One advantage is to considerably reduce the maintenance costs of the hydraulic system consisting of the joint and of the fluid conveying element (for example the flexible pipe) associated with the joint.

One advantage is to enable the fluid conveying element (flexible pipe) associated with the rotatable joint to rotate with respect to the external hydraulic system with relatively reduced friction even in the presence of very high fluid pressure.

One advantage is to make available a light rotatable joint with relatively small overall dimensions and with the possibility of being lubricated simply and effectively.

One advantage is to give rise to a joint that is practical and quick to fit and is constructionally simple and cheap.

Such objects and advantages and still others are all achieved by a joint made according to one or more of the claims set out below.

In one embodiment, a rotatable hydraulically balanced joint comprises two (internal and external) bodies coupled together with the possibility of relative rotation around a rotation axis, in which the pressurised fluid inside the joint generates an axial thrust that would tend to press these two bodies against one another and is balanced by an axial thrust, which is almost equal and contrary, generated hydraulically by a counterpressure chamber comprised between the two bodies and between two annular sealing zones arranged between the two bodies and having operating diameters that are different from one another.

In one embodiment, a rotatable joint comprises: two tubular bodies (internal body and external body) that are free to rotate in relation to one another, and a counterpressure chamber that communicates, via holes obtained on the internal body, with an internal conduit along which the pressurised fluid passes through the joint; the joint may further comprise a compensating chamber that communicates with the atmosphere through a vent on the external body. The compensating chamber and the counterpressure chamber may be made in such a manner that, in the presence of pressurised fluid inside the rotatable joint, the internal body is subjected to two axial forces: a first axial force is equal to the fluid pressure (in the conduit inside the joint) by the area of the circle having a diameter equal to that of the cylindrical surface of the internal body in contact with sealing arrangement interposed hydraulically between the internal conduit and the compensating chamber; a second axial force, in a direction opposite the first, is equal to the pressure in the counterpressure chamber by the area of the circular crown having an external diameter that is the same as that of the cylindrical surface of the external body in contact with sealing arrangement hydraulically interposed between the counterpressure chamber and the atmosphere (in particular through the compensating chamber) and an internal diameter that is the same as that of the cylindrical surface of the internal body in contact with sealing arrangement hydraulically interposed between the counterpressure chamber and the atmosphere.

In one embodiment, the aforesaid diameters of the cylindrical surfaces in contact with the respective sealing arrangement are sized in such a manner that the result of the axial forces (generated by the pressurised fluid) acting on the internal body is substantially nil.

The internal body can thus be in a substantial dynamic equilibrium whilst the axial thrust generated by the pressurised fluid can be discharged on the external body.

In one embodiment, one of the two bodies (the external body) may be made of two parts that are joined together by a removable connection, for example a screw connection, whereby the axial thrust that is discharged on this body can be contrasted by the connection, for example by the thread of the screw coupling.

### BRIEF DESCRIPTION OF DRAWINGS

The invention can be better understood and implemented with reference to the drawings that illustrate an embodiment thereof by way of non-limiting example.

FIG. 1 is a partially sectioned side view of an embodiment of a rotatable joint made according to the invention.

FIG. 2 is an enlarged detail of FIG. 1.

FIGS. 3 to 6 shows four steps in sequence of the connecting operation between the internal body and the external body of the joint in FIG. 1.

### DETAILED DESCRIPTION OF THE INVENTION

With reference to the aforesaid figures, with 1 a rotatable joint for hydraulic connections has been indicated overall. In particular, the joint 1 may be used to connect a fluid conveying pipe, for example a flexible pipe 2 of known type, with a high pressure external hydraulic system (known and not illustrated).

The rotatable joint 1 comprises a tubular internal body 3, having an internal cavity 4 for the passage of pressurised fluid. The internal body 3 may have a first end portion 5 configured for connecting to a fluid conveying pipe. In the specific case the first end portion 5 comprises a hose-bearing portion, intended for forming a crimping zone, which is insertible into the flexible pipe 2 for sealing coupling by means of an external crimping sleeve 6.

The rotatable joint 1 comprises a tubular external body 7 that is rotatably coupled with the internal body 3 around a rotation axis X-X. The external body 7 may have a second end portion 8 configured for connection (for example of the screw type) with a hydraulic installation (known and not illustrated, for example a pump).

The external body 7 may have a first abutting arrangement and a second abutting arrangement. The internal body 3 may be coupled with the external body 7 with the possibility of performing an axial movement with free play (for example of a few millimetres or fractions of a millimetre) bounded on one side by the first abutting arrangement and on the opposite side by the second abutting arrangement. The first abutting arrangement and the second abutting arrangement may respectively comprise a first shoulder 9 and a second shoulder 10, both made on the external body 7. The internal body 3 may have a radial protrusion 11 inserted axially between the first shoulder 9 and the second shoulder 10. The relative axial movement, with free play, between the internal body 3 and the external body 7, may be bounded by the stroke end stops of the radial protrusion 11 against the first shoulder 9 on one side and the second shoulder 10 on the other side.

The external body 7 may comprise a first piece 7a and a second piece 7b assembled together in a removable manner by axial coupling (for example a screw coupling) with an axial stroke end 12.

The rotatable joint 1 comprises a first sealing arrangement (for example a first annular washer 13) arranged for generating a first annular sealing zone between the internal body 3 and the external body 7. The first annular sealing zone will have at least a first operating diameter D1. In particular D1 may be the diameter of an external cylindrical surface of the internal body 3 in contact with the first washer 13.

The rotatable joint 1 comprises a second sealing arrangement (for example a second annular washer 14) arranged for generating a second annular sealing zone between the internal body 3 and the external body 7. The second annular sealing zone will have a second diameter D2 different from the first diameter D1. In particular D2 may be the diameter of an internal cylindrical surface of the external body 8 in contact with the second washer 14. In the specific case D2 is greater than D1.

The rotatable joint 1 comprises a counterpressure chamber 15 bounded between the first sealing arrangement (first washer 13), the second sealing arrangement (second washer 14), the internal body 3 and the external body 7. The counterpressure chamber 15 communicates with the internal cavity 4 for the passage of the pressurised fluid. In particular, the counterpressure chamber 15 may communicate with the internal cavity 4 through one or more holes 16 (radial, for example a crown of radial holes) obtained in the internal body 3.

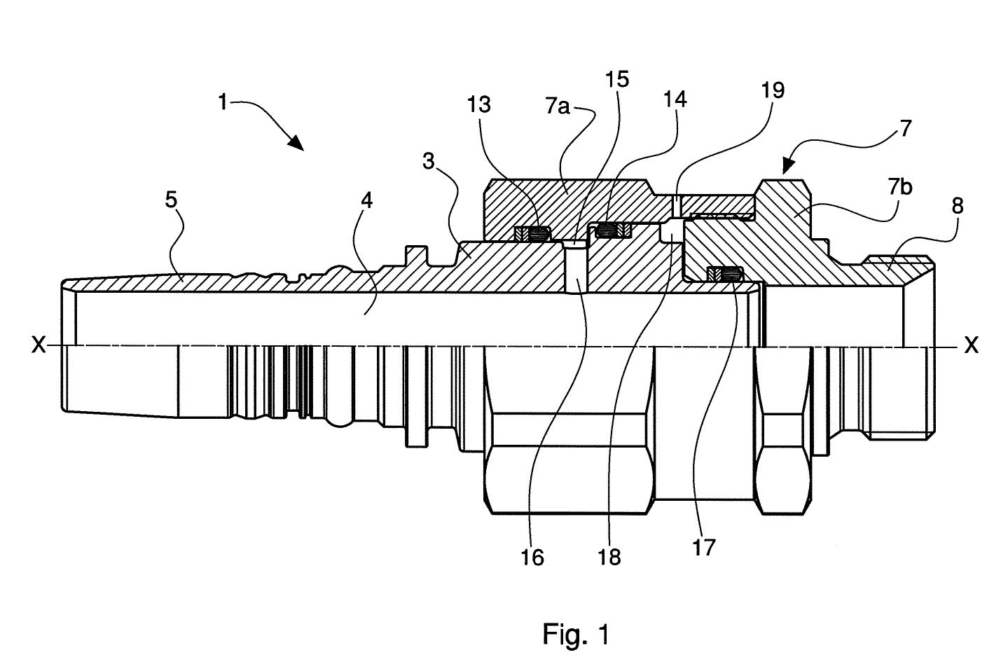

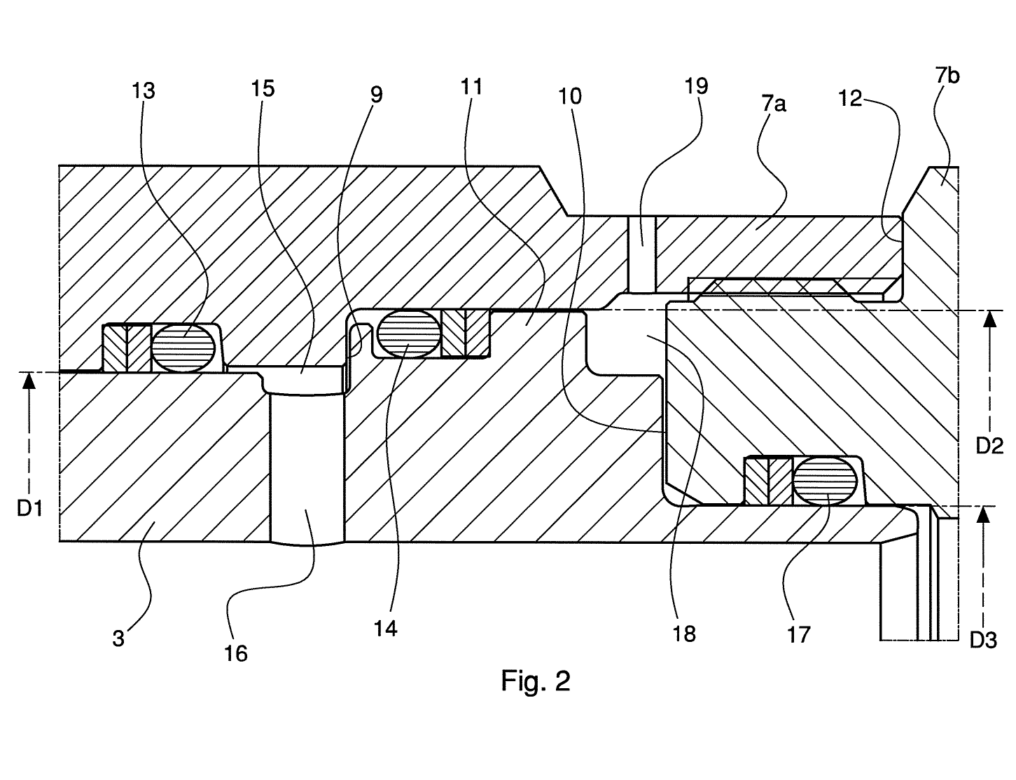

The first diameter D1 and the second diameter D2 may be sized in such a manner that the axial force applied to the internal body 3 by the pressurised fluid in the counterpressure chamber 15 is contrary to the axial force applied to the internal body 3 by the pressurised fluid in the internal cavity 4. In this specific case (D2>D1) the axial thrust generated by the fluid in the counterpressure chamber 15 will be directed (with reference to FIGS. 1 and 2) from left to right.

The rotatable joint 1 may comprise, as in this case, a third sealing arrangement (for example a third annular washer 17) arranged for generating a third annular sealing zone between the internal body 3 and the external body 7.

The third annular sealing zone will have a third diameter D3. In particular D3 may be the diameter of an external cylindrical surface of the internal body 3 in contact with the third washer 17.

The second annular sealing zone is arranged in a zone that, axially (with reference to the rotation axis X-X), is comprised between the first and the third annular sealing zone. The first annular sealing zone is arranged, axially, towards the side of the first end portion 5, whilst the third annular sealing zone is arranged, axially, towards the (opposite) side of the second end portion 8.

The rotatable joint 1 may comprise a compensating chamber 18 bounded between the second sealing arrangement (second washer 14), the third sealing arrangement (third washer 17), the internal body 3 and the external body 7. The compensating chamber 18 communicates with the atmosphere, in particular through one or more vent holes 19 obtained in the external body 7.

The first diameter D1, the second diameter D2 and the third diameter D3 may be sized in such a manner that the result of the axial forces applied to the internal body 3 by the pressurised fluid in the internal cavity 4, in one direction, and in the counterpressure chamber 15, in the opposite direction, is substantially nil. In particular, as the pressure in the counterpressure chamber 15 and the pressure in the cavity 4 inside the joint 1 are considered to be equal, the area of the circle defined by the third diameter D3 may be substantially the same as the area of the circular crown defined between the first diameter D1 and the second diameter D2, as will be explained better below.

In the rotatable joint 1 disclosed here the first diameter D1, the second diameter D2 and the third diameter D3 have been chosen in such a manner that the internal body 3 may be substantially balanced hydraulically. As said, the two bodies, an internal body 3 and an external body 7, can freely perform a rotation around the rotation axis X-X. In use the pressurised fluid inside the joint 1 will generate an axial thrust in one direction (to the left with reference to FIG. 1) that would tend to press these two bodies against one another. This axial thrust may be balanced partially or completely, and thus substantially cancelling the result, by an axial thrust in an opposite direction (to the right with reference to the FIG. 1), which may be almost equal and opposite and is generated hydraulically by the counterpressure chamber 15 which, as is seen, is comprised between the two bodies (internal 3 and external 7) and between the two annular sealing zones operating between the two bodies and having operating diameters (D1 and D2) that are different from one another.

In the counterpressure chamber 15, which, as said, communicates through holes 16 obtained on the internal body 3, with the cavity 4 or internal conduit through which the pressurised fluid flows from one end to another of the joint 1, there will be a pressure that is almost or substantially the same as the pressure of the fluid located in the internal cavity 4. In the compensating chamber 18, which communicates with the atmosphere through a vent on the external body 7, there will be a substantially nil pressure (equal to atmospheric pressure). The rotatable joint 1 may be made, as in this case, in such a manner that, in the presence of pressurised fluid inside the joint, the internal body 3 is subjected to a first axial force (from the right to the left in FIG. 1 or 2), which will be the same as the pressure of the fluid (in the fluid passage cavity 4 inside the joint) by the area of the circle having a diameter (D3) that is the same as that of the cylindrical surface of the internal body 3 in contact with the third sealing arrangement (hydraulically interposed between the internal cavity 4 or conduit and the compensating chamber 18), and a second axial force, in a direction opposite the first (from left to right in FIG. 1 or 2), that will be the same as the pressure in the counterpressure chamber 15 by the area of the circular crown having an external diameter (D2) that is the same as the (internal) cylindrical surface of the external body 7 in contact with the second sealing arrangement (hydraulically interposed between the counterpressure chamber 15 and the atmosphere, for example through the compensating chamber 18) and an internal diameter (D1) the same as that of the (external) cylindrical surface of the internal body 3 in contact with the first sealing arrangement (which is also hydraulically interposed between the counterpressure chamber 15 and the atmosphere).

In other words, the aforesaid diameters (D1, D2, D3) of the cylindrical surfaces in contact with the respective sealing arrangement (first washer 13, second washer 14, third washer 17) will be sized in such a manner that the result of the axial forces acting on the internal body 3 is substantially nil.

The axial force on the internal body 3 generated by the fluid in the counterpressure chamber 15 is proportional to the area of the circular crown comprised between the external diameter (D1) of the internal body 3 in contact with the first annular washer 13 and the internal diameter (D2) of the external body 7 in contact with the second annular washer 14, so this internal diameter (D2) will be greater than that internal diameter (D1) by an amount that is such that axial force is counterbalanced by the axial force in an opposite direction, which is proportional to the area of the circle with a diameter the same as the external diameter (D3) of the internal body 3 in contact with the third annular washer 17.

The internal body 3 may thus be in a substantial axial dynamic equilibrium, whereas the axial thrust generated by the pressurised fluid will be discharged on the external body 7. If the latter is made of two parts that are joined together (in particular by a removable connection, for example a screw coupling), the axial thrust that will be discharged on the external body 7 may be contrasted, as in this example, by the thread of a screw coupling. The internal body 3, being dynamically balanced and being substantially in equilibrium in an axial direction, can rotate freely in relation to the external body 7 without any need to interpose rolling elements or other revolving elements providing (axial) support for rolling.

With the first piece 7a of the external body, as in this example, the first abutting arrangement (first shoulder 9) and/or the first annular sealing zone and/or the second annular sealing zone may be associated. With the second piece 7b of the external body the second abutting arrangement (second shoulder 10) and/or the third annular sealing zone and/or the second end portion 8 may be associated.

The first piece 7a of the external body may be made entirely of a single piece. The second piece 7b of the external body may be made entirely of a single piece. The internal body 3 may be made entirely of a single piece.

Owing to the aforesaid axial dynamic balancing, the rotatable joint 1 may be, as in this specific example, devoid of revolving elements, for example balls or rollers or other rolling elements providing (axial and/or radial) rotation support interposed (radially and/or axially) between the internal body 3 and the external body 7.

The rotatable joint 1 may be wholly of the free-flow type, as in this specific case, whereby it internally defines a fluid passage that is devoid (from one end to the other end of the joint 1, in particular from the first end portion 5 to the second end portion 8) of a valve arrangement, for example check valves, on/off valves, flowrate control valves, etc.

In the specific case the first sealing arrangement (first washer 13) is housed in a hollow seat (internal annular throat) obtained on an internal surface (of the first piece 7a) of the external body 7. In the specific case the second sealing arrangement (second washer 14) is housed in a hollow seat (external annular throat) obtained on an external surface (of the radial protrusion 11) of the internal body 3. In the specific case the third sealing arrangement (third washer 17) is housed in a hollow seat (internal annular throat) obtained on an internal surface (of the second piece 7b) of the external body 7.

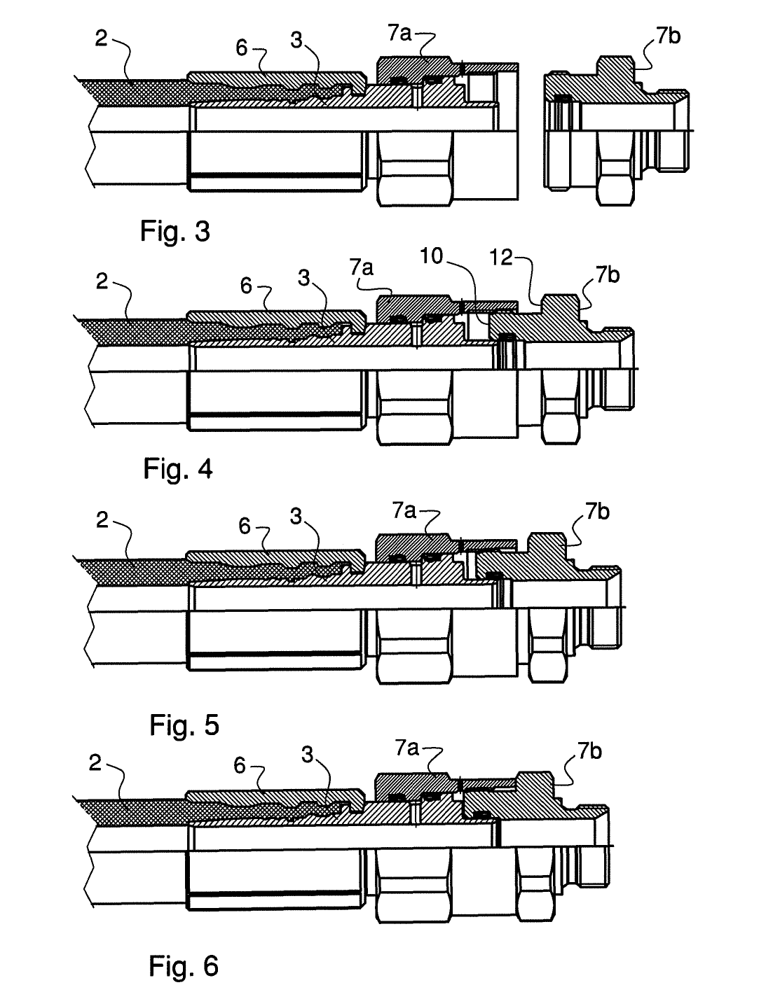

In use, a flexible pipe 2 can be crimped (in the known manner) on the first end portion 5 (of the internal body 3). The joint 1 is assembled simply and practically by a screw connection (as illustrated in the sequence of FIGS. 3 to 6) that joins the first piece 7a (previously coupled around the internal body 3) to the second piece 7b. The joint 1 can be connected to the external hydraulic system (known and not illustrated, for example a pump) by the second end portion 8 (of the external body 7). The joint 1 will then be traversed by pressurised fluid, also at very high pressures, for example up to 350 bar.

Owing to the axial movement with free play of the internal body 3 (movement bound in this case in the two directions by two shoulders 9 and 10 of the external body), and owing to the substantially axial dynamic balancing of the internal body 3, a relative rotation between the internal body 3 and the external body 7 is possible also in the presence of very high fluid pressures, there being at the same time relatively reduced friction between the adjacent surfaces that are in (rotational) motion in relation to one another.

1-18. (canceled)

19. A rotatable joint comprising:
a tubular internal body having an internal cavity for the passage of pressurised fluid, said internal body having a first end portion configured for connecting to a hydraulic element, in particular to a flexible pipe for conveying fluid;
a tubular external body rotatably coupled with said internal body around a rotation axis, said external body having a second end portion configured for connecting to a hydraulic system;
a first sealing arrangement arranged for generating a first annular sealing zone between said internal body and said external body, said first annular sealing zone having at least a first diameter;
a second sealing arrangement arranged for generating a second annular sealing zone between said internal body and said external body, said second annular sealing zone having at least a second diameter that is different from said first diameter;
a counterpressure chamber bounded between said first sealing arrangement, said second sealing arrangement, said internal body and said external body, said counterpressure chamber communicating with said internal cavity, said first diameter and second diameter being sized in such a manner that the axial force applied to said internal body by pressurised fluid in said counterpressure chamber is contrary to the axial force applied to said internal body by pressurised fluid in said internal cavity.

20. The rotatable joint according to claim 19, wherein said external body has a first abutting arrangement and a second abutting arrangement, said internal body being coupled with said external body with the possibility of performing an axial movement with free play bounded on one side by said first abutting arrangement and on the opposite side by said second abutting arrangement.

21. The rotatable joint according to claim 20, wherein said first abutting arrangement and said second abutting arrangement respectively comprise a first shoulder and a second shoulder of said external body, said internal body having a radial protrusion inserted between said first shoulder and second shoulder, said axial movement with free play being bounded by the stroke end positions of said radial protrusion against said first shoulder and second shoulder.

22. The rotatable joint according to claim 21, comprising:
a third sealing arrangement arranged for generating a third annular sealing zone between said internal body and said external body, said third annular sealing zone having a third diameter; and
a compensating chamber bounded within a space comprised between said second sealing arrangement , said third sealing arrangement , said internal body and said external body, said compensating chamber communicating with the atmosphere.

23. The rotatable joint according to claim 22, wherein said first diameter, second diameter and third diameter are sized in such a manner that the result of the axial forces applied to said internal body by the pressurised fluid located in said internal cavity and in said counterpressure chamber is substantially nil.

24. The rotatable joint according to claim 23, wherein the area of the circle having said third diameter is substantially equal to the area of the circular crown defined between said first diameter and second diameter.

25. The rotatable joint according to claim 20, wherein said external body comprises a first piece and a second piece assembled together in a removable manner by axial coupling with an axial stroke end, said first piece being associated with said first abutting arrangement and with said first and second annular sealing zone.

26. The rotatable joint according to claim 25, wherein said second piece is associated with said second abutting arrangement , with said third annular sealing zone and with said second end portion.

27. The rotatable joint according to claim 25, wherein said first piece is made integrally of a single piece and/or wherein said second piece is made integrally of a single piece.

28. The rotatable joint according to claim 19, wherein said internal body is made integrally of a single piece.

29. The rotatable joint according to claim 19, wherein said counterpressure chamber communicates with said internal cavity through one or more holes obtained in said internal body.

30. The rotatable joint according to claim 19, and being devoid of revolving elements, for example balls or rollers, to support rotation interposed between said internal body and said external body.

31. The rotatable joint according to claim 19, and being integrally of the free flow type so as to define internally a fluid passage that is devoid of an intercepting arrangement.

32. The rotatable joint according to claim 19, comprising:
a third sealing arrangement arranged for generating a third annular sealing zone between said internal body and said external body, said third annular sealing zone having a third diameter; and
a compensating chamber communicating with the atmosphere and bounded between said second sealing arrangement, said third sealing arrangement, said internal body and said external body.

33. The rotatable joint according to claim 32, wherein said first diameter, second diameter and third diameter are sized in such a manner that the result of the axial forces applied to said internal body by the pressurised fluid located in said internal cavity and in said counterpressure chamber is substantially nil.

34. The rotatable joint according to claim 33, wherein the area of the circle having said third diameter is substantially equal to the area of the circular crown defined between said first diameter and second diameter.

35. The rotatable joint according to claim 32, wherein said compensating chamber communicates with the atmosphere through one or more venting holes obtained in said external body.

36. The rotatable joint according to claim 19, wherein said first end portion comprises a hose-bearing portion that is insertible into a flexible pipe for sealing coupling through crimping.
